(19) United States
(12) Patent Application Publication
(10) Pub. No.: US 2024/0411194 A1
(43) Pub. Date: Dec. 12, 2024

(54) Smart Glass Systems Using a Single Pair of Wires for Data and Power Transmission

(71) Applicant: SAGE Electrochromics, Inc., Faribault, MN (US)

(72) Inventor: David Ryan Buszmann, Elko New Market, MN (US)

(73) Assignee: SAGE Electrochromics, Inc., Faribault, MN (US)

(21) Appl. No.: 18/669,382

(22) Filed: May 20, 2024

Related U.S. Application Data
(60) Provisional application No. 63/507,709, filed on Jun. 12, 2023.

(51) Int. Cl. G02F 1/157; G02F 1/153; H04L 12/10

(52) U.S. Cl. CPC G02F 1/157; G02F 1/1533; H04L 12/10

(57) ABSTRACT

A method implemented by a controller associated with a smart glass unit in a smart glass system includes receiving, by the controller over a single pair of wires and from another controller, data concerning a tinting state of another smart glass unit associated with the other controller. The method includes receiving, by the controller over the single pair of wires, a control command indicating that the smart glass unit associated with the controller is to change or maintain a tinting state. The method includes determining, by the controller, an amount of power available over the single pair of wires for changing or maintaining the tinting state of the smart glass unit based on the data. The method includes updating, by the controller, the tint state of the smart glass unit based on the amount of available power over the single pair of wires and the one or more control commands.

### PRIORITY APPLICATION

This application claims benefit of priority to U.S. Provisional Application Ser. No. 63/507,709, entitled “Smart Glass Systems Using a Single Pair of Wires for Data and Power Transmission,” filed Jun. 12, 2023, and which is hereby incorporated herein by reference in its entirety.

### FIELD OF THE DISCLOSURE

The present disclosure is directed to one or more smart glass units, and more specifically to various approaches for using a single pair of wires for data and power transmission to operate smart glass units.

### BACKGROUND

Smart glass may be used to decrease heat transfer through a window and/or reduce the transmission of visible light to provide tinting or shading. Smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Many smart glass systems utilize complicated wire configurations to achieve sufficient functionality and operability.

### SUMMARY

In some aspects, a system is provided. The system includes one or more smart glass units. The system also includes one or more controllers for respective smart glass units. A respective controller of the one or more controllers includes a connector configured to receive a single pair of wires. The respective controller of the one or more controllers also includes an interface to electrically connect to at least one smart glass unit of the one or more smart glass units. The respective controller of the one or more controllers further includes control circuitry configured to electrically control the at least one smart glass unit, via the interface, to change or maintain a tint of the at least one smart glass unit based on data received, via the connector, on the single pair of wires. The respective controller of the one or more controllers is configured to receive power, via the connector, for powering the control circuitry and for powering the interface to the at least one smart glass unit on the same single pair of wires on which the data is received.

In some aspects, a smart glass unit system is provided. The smart glass unit includes a single pair of wires extending from a smart glass unit system (e.g., a controller associated with one or more smart glass units). The single pair of wires are configured to communicate data and transmit power between the smart glass unit and at least one other smart glass unit. The smart glass unit system also includes a controller. The controller includes a connector configured to receive the single pair of wires. The controller also includes an interface to electrically connect to the smart glass unit. The controller further includes control circuitry configured to electrically control the smart glass unit via the interface to change or maintain a tint of the smart glass pane based on the data received, via the connector, on the single pair of wires. The controller is configured to receive power on the same single pair of wires on which the data is received, via the first connector, for powering the control circuitry, for powering the interface to the smart glass pane, and for providing power to the smart glass unit. In some aspects, the controller may be external to the smart glass unit so that the controller and the smart glass unit appear as separate components forming the smart glass unit system. In some aspects, the controller may be an integrated controller that is integrated into a housing (e.g., a frame) shared by the smart glass unit and/or attached to the smart glass unit to form the smart glass unit system.

In some aspects, a method implemented by a controller associated with a smart glass unit in a smart glass system is provided. The method includes receiving, by the controller over a single pair of wires and from another controller, data concerning a tinting state of another smart glass unit associated with the other controller. The method also includes receiving, by the controller over the single pair of wires, a control command indicating that the smart glass unit associated with the controller is to change or maintain a tinting state. The method further includes determining, by the controller, an amount of power available over the single pair of wires for changing or maintaining the tinting state of the smart glass unit based on the data. In addition, the method includes updating, by the controller, the tint state of the smart glass unit based on the amount of available power over the single pair of wires and the one or more control commands.

### BRIEF DESCRIPTION OF THE DRAWINGS

FIG. 1 illustrates a perspective view of an example EC system according to some aspects of this disclosure.

FIG. 2 illustrates a block diagram of an example system according to some aspects of this disclosure.

FIG. 3 illustrates a perspective view of an example single pair cable according to some aspects of this disclosure.

FIG. 4 illustrates a block diagram of an example smart glass unit system according to some aspects of this disclosure.

FIG. 5 illustrates a block diagram of an example system according to some aspects of this disclosure.

FIG. 6 illustrates a block diagram of an example system according to some aspects of this disclosure.

FIG. 7 illustrates a block diagram of an example system according to some aspects of this disclosure.

FIG. 8 illustrates a block diagram of an example method according to some aspects of this disclosure.

FIG. 9 illustrates an example computer system that may be used in some embodiments.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may be as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Many smart glass systems utilize complicated wire configurations to achieve sufficient functionality and operability.

Due to the increased functionality and size of EC devices, EC system wiring can be extensive and complicated. Power connections (e.g., AC power connections) and other cables may provide additional complexity and provide additional size or bulk. In some cases, to reduce the bulkiness and complexity of EC systems, Power over Ethernet (POE) cable may use two or more ethernet pairs per cable. While PoE ethernet cable using two or more ethernet pairs per cable may reduce some bulkiness and complexity, such PoE ethernet cable may be still have some bulkiness and complexity. However, EC systems utilizing a single pair of wires (e.g., single pair ethernet (SPE) and Power Over Data Line (PoDL)) may simplify EC systems, reduce their weight and bulkiness, and also reduce their overall costs. In some aspects, an EC system utilizing a single pair of wires may also be used for daisy-chain configurations further simplifying EC systems, further reducing their weight and bulkiness, and further reducing their overall costs.

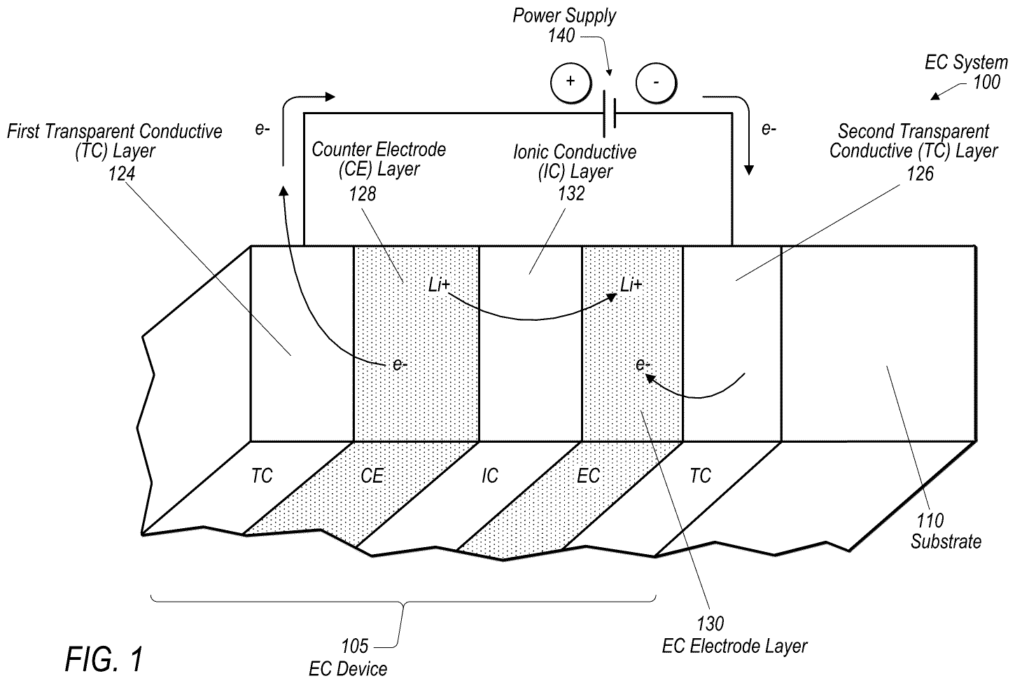

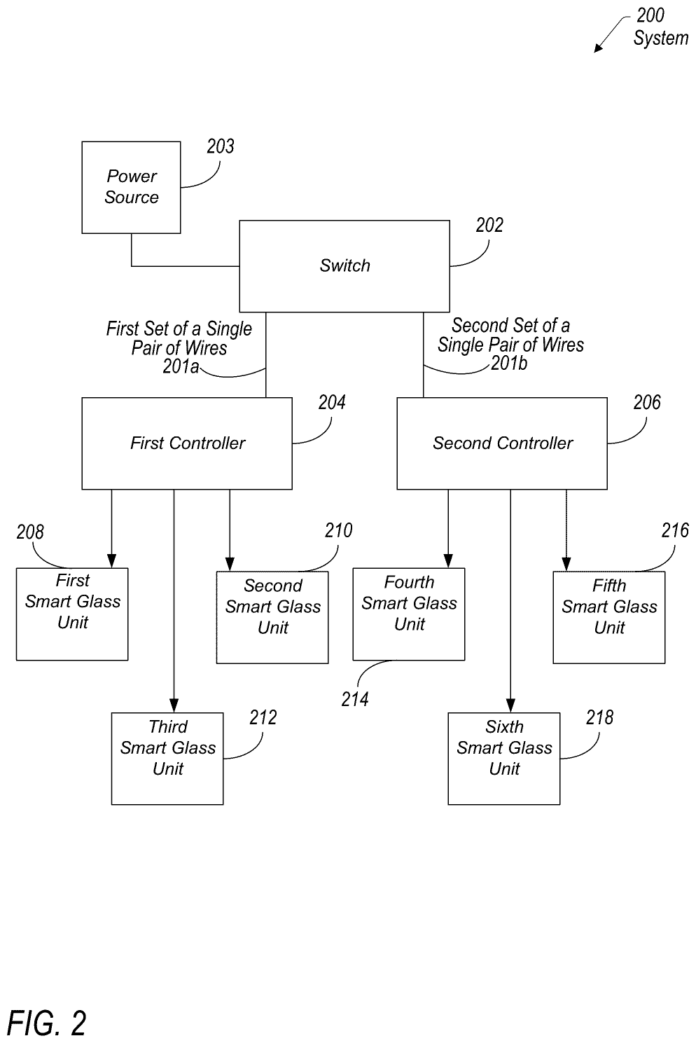

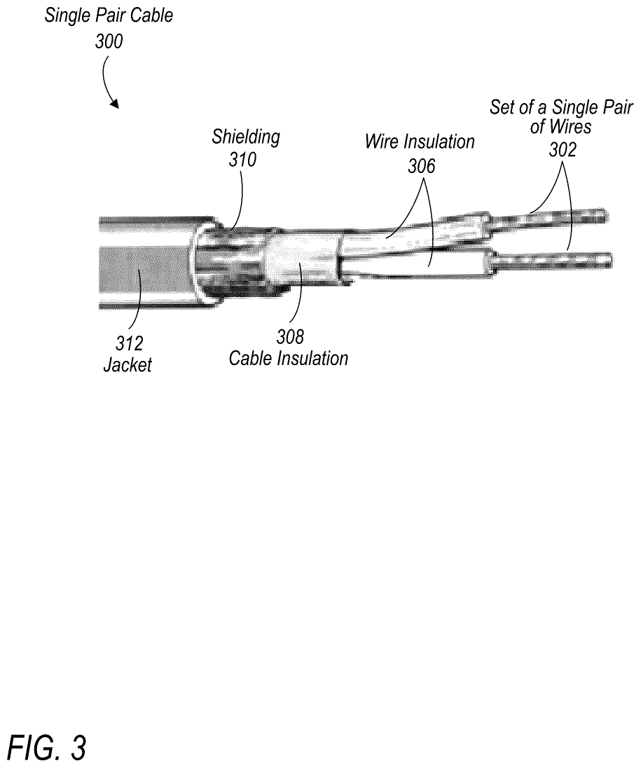

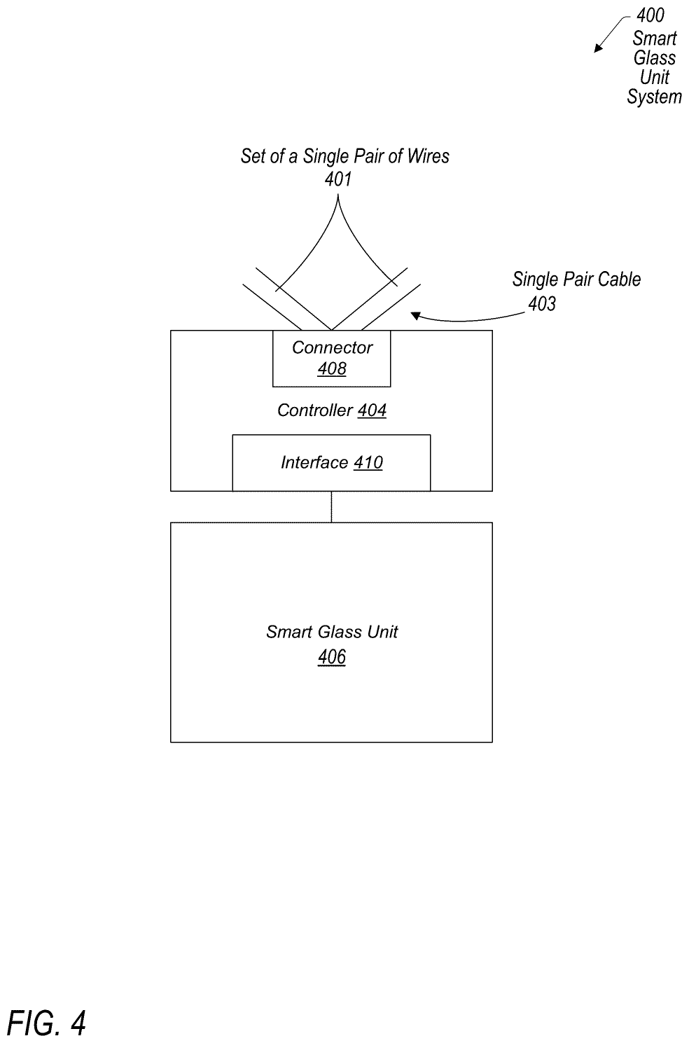

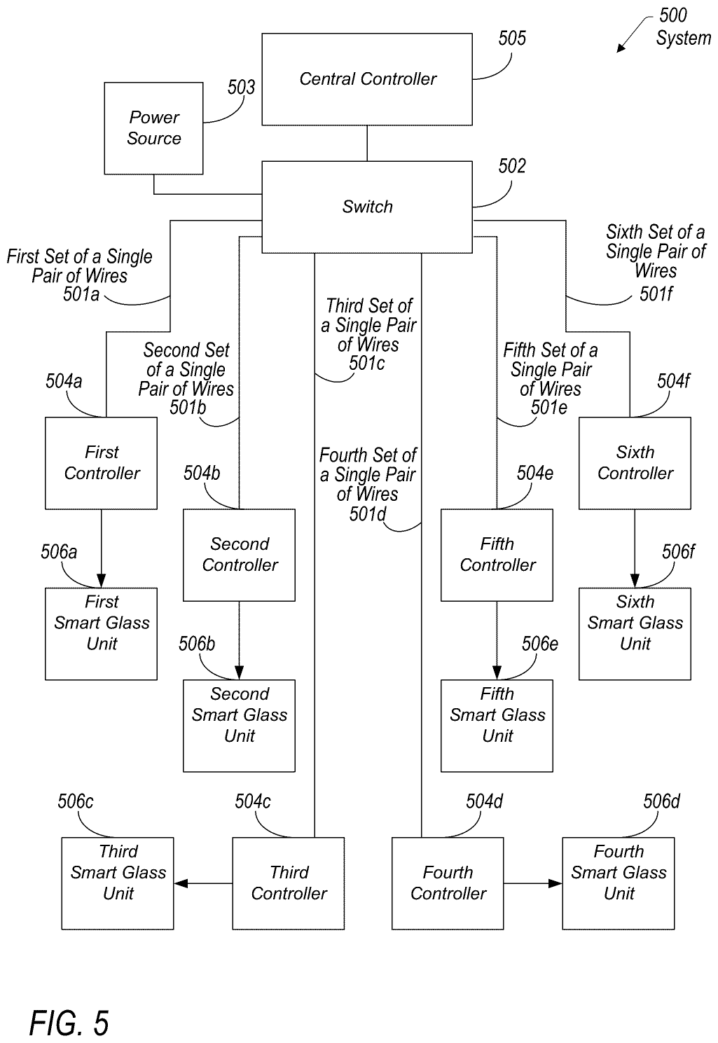

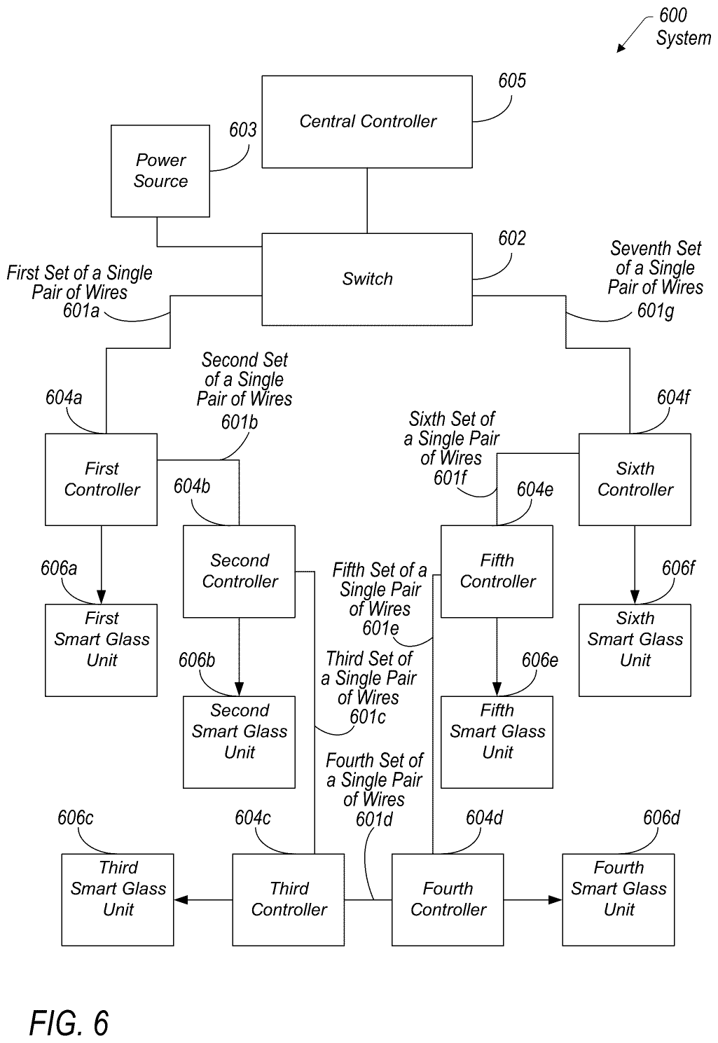

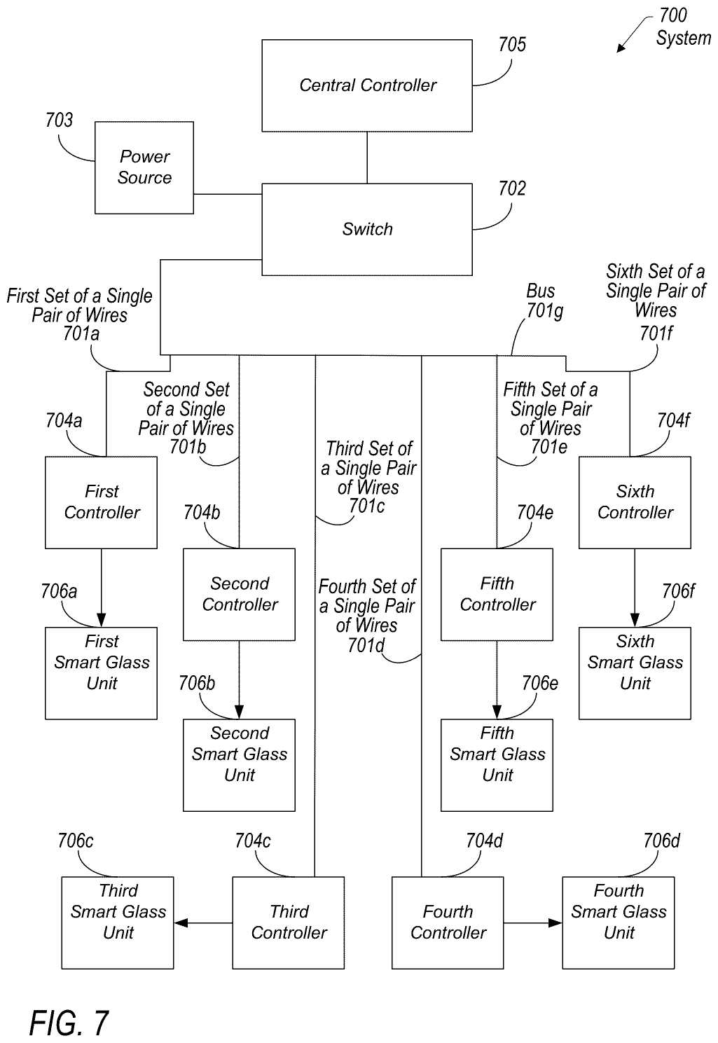

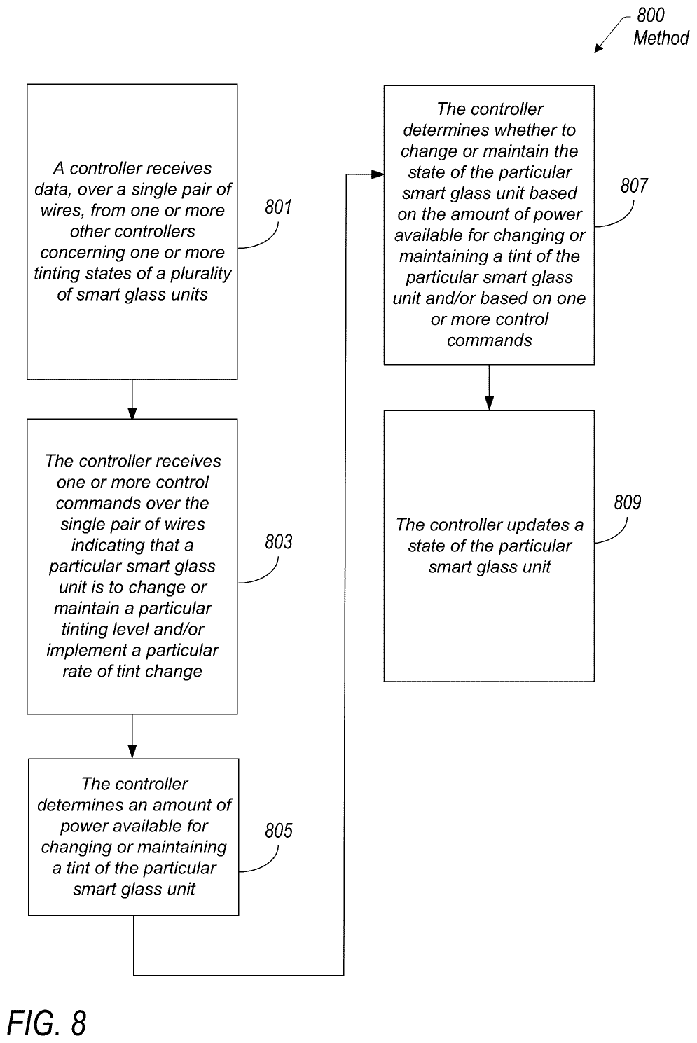

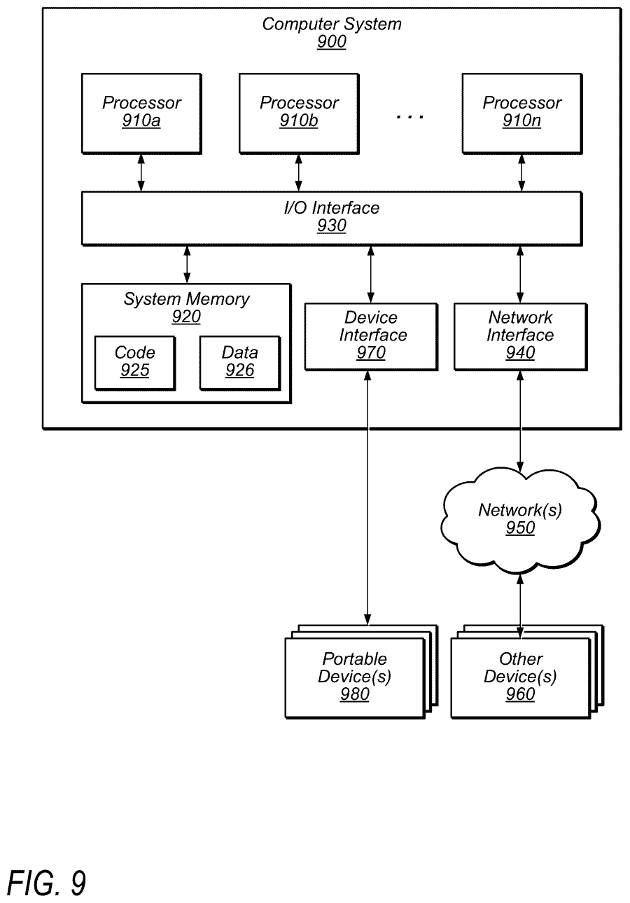

FIG. 1 illustrates a perspective view of an example EC system 100 according to some aspects of this disclosure. The EC system 100 may include one or more same or similar features as the features described with respect to or illustrated in FIGS. 2, 3, 4, 5, 6, 7, 8, and 9. For example, the EC system 100 may include one or more same or similar features as the features described with respect to the system 200 described with respect to FIG. 2, the single pair cable 300 described with respect to FIG. 3, the smart glass unit system 400 described with respect to FIG. 4, the system 500 described with respect to FIG. 5, the system 600 described with respect to FIG. 6, the system 700 described with respect to FIG. 7, and the method 800 described with respect to FIG. 8, and/or the computer system 900 described with respect to FIG. 9. FIG. 1, as with the other included figures, is shown for illustrative purposes and does not limit either the possible embodiments of the present invention or the claims.

In this example, the EC system 100 may include an EC device 105 secured to a substrate 110. The EC device 105 may be a non-limiting example of a smart glass or smart glass unit as provided herein. The EC device 105 may include a thin film which may be deposited on to the substrate 110. The EC device 105 may include a first transparent conductive (TC) layer 124 and a second TC layer 126 in contact with the substrate 110. In some aspects, the first TC layer 124 and the second TC layer 126 may be, or may include, one or more transparent conductive oxide (TCO) layers. The substrate 110 may include one or more optically transparent materials, e.g., glass, plastic, and the like. The EC device 105 may also include one or more active layers. For example, the EC device 105 may include a counter electrode (CE) layer 128 in contact with the first TC layer 124 and an EC electrode layer 130 in contact with the second TC layer 126. An ionic conductor (IC) layer 132 may be positioned in-between (e.g., “sandwiched” between) the CE layer 128 and the EC electrode layer 130. The EC system 100 may include a power supply 140 which may provide regulated current or voltage to the

EC device 105. Transparency of the EC device 105 may be controlled by regulating density of charges (or lithium ions) in the CE layer 128 and/or the EC electrode layer 130 of the EC device 105. For instance, when the EC system 100 applies a positive voltage from the power supply 140 to the first TC layer 124, lithium ions may be inserted into the EC electrode layer 130. In some aspects, when the EC system 100 applies a positive voltage from the power supply 140 to the first TC layer 124, lithium ions may be driven across the IC layer 132 and inserted into the EC electrode layer 130. Simultaneously, charge-compensating electrons may be extracted from the CE layer 128, may flow across the external circuit, and may flow into the EC electrode layer 130. Transfer of lithium ions and associated electrons from the CE layer 128 to the EC electrode layer 130 may cause the EC device 105 to become darker—e.g., the visible light transmission of the EC device 105 may decrease. Reversing the voltage polarity may cause the lithium ions and associated charges to return to their original layer, the CE layer 128, and as a result, the EC device 105 may return to a clear state—e.g., the visible light transmission of the EC device 105 may increase.

As described herein, a smart glass or device such as the EC device 105 of FIG. 1 may receive a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass.

FIG. 2 illustrates a block diagram of an example system 200 according to some aspects of this disclosure. The system 200 may include one or more same or similar features as the features described with respect to or illustrated in FIGS. 1, 3, 4, 5, 6, 7, 8, and 9. For example, the system 200 may include one or more same or similar features as the features described with respect to the EC system 100 described with respect to FIG. 1, the single pair cable 300 described with respect to FIG. 3, the smart glass unit system 400 described with respect to FIG. 4, the system 500 described with respect to FIG. 5, the system 600 described with respect to FIG. 6, the system 700 described with respect to FIG. 7, and the method 800 described with respect to FIG. 8, and/or the computer system 900 described with respect to FIG. 9. FIG. 2, as with the other included figures, is shown for illustrative purposes and does not limit either the possible embodiments of the present invention or the claims.

As shown in FIG. 2, the system 200 includes a switch 202 (e.g., a POE or powered switch), a power source 203, a first controller 204, a second controller 206, one or more smart glass units, a first set of a single pair of wires 201a (e.g., a set of a single pair of wires 302 illustrated in FIG. 3), and a second set of a single pair of wires 201b (e.g., a set of a single pair of wires 302 illustrated in FIG. 3). The power source 203 may be configured to provide power (e.g., alternating current (AC) power) through the switch 202 to the first controller 204 and the second controller 206, via the first set of the single pair of wires 201a, and the second set of the single pair of wires 201b, respectively, in order to change or maintain a tint of respective smart glass units. The first controller 204 and the second controller 206 may also communicate data (e.g., control commands) between each other, via the switch 202, the first set of the single pair of wires 201a, and the second set of the single pair of wires 201b, for allocating power to the respective smart glass units. For example, the first controller 204 and the second controller 206 may receive power from the power source 203 via the switch 202 and the first set of the single pair of wires 201a and the second set of the single pair of wires 201b, respectively. The first controller 204 may allocate power to the first smart glass unit 208 (e.g., the EC device 105 of FIG. 1), the second smart glass unit 210 (e.g., the EC device 105 of FIG. 1), and/or the third smart glass unit 212 (e.g., the EC device 105 of FIG. 1) to change or maintain tinting of one or more of those units. The second controller 206 may allocate power to the fourth smart glass unit 214 (e.g., the EC device 100 of FIG. 1), the fifth smart glass unit 216 (e.g., the EC device 100 of FIG. 1), and/or the sixth smart glass unit 218 (e.g., the EC device 100 of FIG. 1) to change or maintain tinting of one or more of those units.

In some aspects, the power source 203 may be configured to provide power (e.g., alternating current (AC) power) through the switch 202 to a central controller (not shown) (e.g., the central controller 505 illustrated in FIG. 5). A central controller (not shown in FIG. 2) (e.g., the central controller 505 illustrated in FIG. 5) may control the supply of power from the power source 203 through the switch 202 to the first controller 204 and the second controller 206, via the first set of the single pair of wires 201a, and the second set of the single pair of wires 201b, respectively, in order to change or maintain a tint of respective smart glass units. The central controller may also communicate data (e.g., control commands) to the first controller 204 and the second controller 206 so that the first controller 204 and the second controller 206 may allocate power to the respective smart glass units.

The first controller 204 and the second controller 206 may transmit the data between each other to determine whether enough power is available from the power source 203 to change or maintain tinting of one or more smart glass units and/or to determine a speed by which a tinting of one or more units may change. For example, the first controller 204 may receive data from the second controller 206 indicating that none of the fourth smart glass unit 214, the fifth smart glass unit 216, or the sixth smart glass unit 218 are being tinted or are changing tint. The first controller 204 may receive, via the switch 202, an external signal from a light sensor (not shown), a human interface device (not shown) command signal, or an external signal indicative of a preset timing schedule for maintaining and/or modifying tint that the first smart glass unit 208, the second smart glass unit 210, and the third smart glass unit 212 are each to increase tinting. Based on the data received from the second controller 206, the first controller 204 may determine that there is enough power to increase tinting for the first smart glass unit 208, the second smart glass unit 210, and the third smart glass unit 212 and how fast each of the first smart glass unit 208, the second smart glass unit 210, and the third smart glass unit 212 can increase their respective tints. As another example, the first controller 204 may receive data from the second controller 206 indicating that all of the fourth smart glass unit 214, the fifth smart glass unit 216, or the sixth smart glass unit 218 are being tinted or are changing tint. The first controller 204 may receive via the switch 202, an external signal from a light sensor (not shown), a human interface device (not shown) command signal, or an external signal indicative of a preset timing schedule for maintaining and/or modifying tint that the first smart glass unit 208, the second smart glass unit 210, and the third smart glass unit 212 are each to increase tinting. Based on the data received from the second controller 206, the first controller 204 may determine that there is enough power to increase tinting for the first smart glass unit 208, the second smart glass unit 210, and the third smart glass unit 212, but that at least one of the first smart glass unit 208, the second smart glass unit 210, or the third smart glass unit 212 is to increase its respective tints at a relatively slower rate in order to not exceed the available power. As yet another example, the first controller 204 may receive data from the second controller 206 indicating that all of the fourth smart glass unit 214, the fifth smart glass unit 216, or the sixth smart glass unit 218 are being tinted or are changing tint. The first controller 204 may receive a signal from a light sensor (not shown) or via a preset timing schedule that the first smart glass unit 208, the second smart glass unit 210, and the third smart glass unit 212 are each to increase tinting. Based on the data received from the second controller 206, the first controller 204 may determine that there is not enough power to increase tinting for the first smart glass unit 208, the second smart glass unit 210, and the third smart glass unit 212. The first controller 204 may abstain from increasing the tints of the smart glass unit until enough power is available or until another external signal is received providing one or more different commands.

FIG. 3 illustrates a perspective view of an example single pair cable 300 according to some aspects of this disclosure. The single pair cable 300 and/or one or more components of the signal pair cable 300 may be included in any one or more of the systems and devices described herein with respect to FIGS. 1, 2, 4, 5, 6, 7, 8, and 9. FIG. 3, as with the other included figures, is shown for illustrative purposes and does not limit either the possible embodiments of the present invention or the claims. As shown in FIG. 3, the single pair cable 300 includes a set of a single pair of wires 302, wire insulation 306, cable insulation 308, shielding 310, and a jacket 312. In some aspects, the single pair cable 300 may not include one or more features such as the shielding 310. The single pair cable 300 (e.g., or at least the set of the single pair of wires 302) may be used to carry power and data between controllers in an EC device, EC system, smart glass unit, and/or smart glass system for powering and providing control commands to control circuitry of a controller of a smart glass unit as well as for providing power to smart glass unit of the smart glass unit as described herein. In some aspects, the single pair of wires 302 may include single pair ethernet (SPE) and Power Over Data Line (PoDL). The wire insulation 306 provides electrical insulation between the set of the single pair of wires 302, themselves. The cable insulation 308 insulates the set of the single pair of wires from external conductors. The shielding 310 protects the set of the single pair of wires 302, the wire insulation 306, and/or the cable insulation 308 from potential physical or structural damage from an external force. The jacket 312 retains the set of the single pair of wires 302, the wire insulation 306, the cable insulation 308, and/or the shielding 310 together.

FIG. 4 illustrates a block diagram of an example smart glass unit system 400 according to some aspects of this disclosure. The smart glass unit system 400 may include one or more same or similar features as the features described with respect to or illustrated in FIGS. 1, 2, 3, 5, 6, 7, 8, and 9. For example, the smart glass unit system 400 may include one or more same or similar features as the features described with respect to the EC system 100 described with respect to FIG. 1, the system 200 described with respect to FIG. 2, the system 500 described with respect to FIG. 5, the system 600 described with respect to FIG. 6, the system 700 described with respect to FIG. 7, and the method 800 described with respect to FIG. 8, and/or the computer system 900 described with respect to FIG. 9. The smart glass unit system 400 may utilize and/or include the single pair cable 300 and/or the set of the single pair of wires 302 illustrated in FIG. 3. FIG. 4, as with the other included figures, is shown for illustrative purposes and does not limit either the possible embodiments of the present invention or the claims.

As shown in FIG. 4, the smart glass unit system 400 includes a controller 404 and a smart glass unit 406 (e.g., the EC system 100 of FIG. 1). In some aspects, the smart glass unit system 400 may include a controller 404 and a plurality of smart glass units (e.g., the first controller 204 and the first, second, and third smart glass units 208, 210, and 212, respectfully, as illustrated in FIG. 2). The controller 404 may also include a connector 408, an interface 410, and control circuitry. The connector 408 may be configured to receive the single pair of wires 401. In some aspects, the connector 408 may be configured to receive the single pair cable 403 (e.g., the single pair cable 300 illustrated in FIG. 3) including the single pair of wires 401 (e.g., the set of the single pair of wires 302 illustrated in FIG. 3). In some aspects, the controller 404 may include two or more connectors 408 each for receiving a set of the single pair of wires 401. For example, the controller 404 may include a first connector for receiving a set of first the single pair of wires for power and data transfer with another controller (e.g., a central controller, a controller of another smart glass unit system) and/or with a switch (e.g., switch 202 illustrated in FIG. 2) and a second connector for receiving a set of second the single pair of wires for power and data transfer with a second controller of a second smart glass unit system. In some aspects, the controller 404 may include a plurality of connectors for receiving the single pair of wires for power and data transfers with a plurality of other smart glass unit systems, switches, and/or central controllers. The interface 410 may be configured to electrically connect the controller 404 to the smart glass unit 406. In some aspects, for example as shown in FIG. 2, the controller 404 may be electrically connected to a plurality of smart glass units. As such, the controller 404 may include a plurality of interfaces 410 for electrically connecting the controller 404 to respective smart glass units of the plurality of smart glass units. The control circuitry may be configured to electrically control the smart glass unit(s) 406, via the interface 410, to change or maintain a tint of the at least one smart glass unit 406 based on data received, via the connector 408, on the set of single pair of wires 401 (e.g., the single pair cable 403 including the set of the single pair of wires 401).

FIG. 5 illustrates a block diagram of an example system 500 according to some aspects of this disclosure. The system 500 may include one or more same or similar features as the features described with respect to or illustrated in FIGS. 1, 2, 3, 4, 6, 7, 8, and 9. For example, the system 500 may include one or more same or similar features as the features described with respect to the EC system 100 described with respect to FIG. 1, the system 200 described with respect to FIG. 2, the smart glass unit system 400 described with respect to FIG. 4, the system 600 described with respect to

FIG. 6, the system 700 described with respect to FIG. 7, and the method 800 described with respect to FIG. 8, and/or the computer system 900 described with respect to FIG. 9. The system 500 may utilize and/or include the single pair cable 300 and/or the set of the single pair of wires 302 illustrated in FIG. 3. FIG. 5, as with the other included figures, is shown for illustrative purposes and does not limit either the possible embodiments of the present invention or the claims.

As shown in FIG. 5, the system 500 includes a switch 502 (e.g., a POE or powered switch), a power source 503, a central controller 505, a plurality of controllers, a plurality of smart glass units, a plurality of sets of the single pair of wires (e.g., set of the single pair of wires 302 illustrated in FIG. 3). The power source 503 may be configured to provide power (e.g., alternating current (AC) power) through the switch 502 to a first controller 504a via a first set of the single pair of wires 501a, to a second controller 504b via a second set of the single pair of wires 501b, to a third controller 504c via a third set of the single pair of wires 501c, to a fourth controller 504d via a fourth set of the single pair of wires 501d, to a fifth controller 504e via a fifth set of the single pair of wires 501e, and to a sixth controller 504f via a sixth set of the single pair of wires 501f. Respective controllers may be electrically connected to respective smart glass units in order to change or maintain a tint of respective smart glass units. For example, a first controller 504a may be electrically connected to the first smart glass unit 506a, the second controller 504b may be electrically connected to the second smart glass unit 506b, the third controller 504c may be electrically connected to the third smart glass unit 506c, the fourth controller 504d may be electrically connected to the fourth smart glass unit 506d, the fifth controller 504e may be electrically connected to the fifth smart glass unit 506e, and the sixth controller 504f may be electrically connected to the sixth smart glass unit 506f.

The power source 503 may be configured to provide power (e.g., alternating current (AC) power), via the switch 502, to the system 500. The central controller 505 may control the supply of power, via the switch 502, to a plurality of controllers for changing and/or maintaining a tint of respective smart glass units. For example, the central controller 505 may control the supply of power to the first controller 504a via the first set of the single pair of wires 501a, to the second controller 504b via the second set of the single pair of wires 501b, to the third controller 504c via the third set of the single pair of wires 501c, to the fourth controller 504d via the fourth set of the single pair of wires 501d, to the fifth controller 504e via the fifth set of the single pair of wires 501e, and to the sixth controller 504f via the sixth set of the single pair of wires 501f. Using the power allocate by the central controller 505 to the plurality of controllers, the controllers may provide power to the smart glass units.

For example, the first controller 504a may provide power to the first smart glass unit 506a, the second controller 504b may provide power to the second smart glass unit 506b, the third controller 504c may provide power to the third smart glass unit 506c, the fourth controller 504d may provide power to the fourth smart glass unit 506d, the fifth controller 504e may provide power to the fifth smart glass unit 506e, the sixth controller 504f may provide power to the sixth smart glass unit 506f.

The central controller 505 may also communicate data (e.g., control commands) to the first controller 504a, the second controller 504b, the third controller 504c, the fourth controller 504d, the fifth controller 504e, and the sixth controller 504f so that the respective controllers may allocate power to the respective smart glass units. For example, the central controller 505 may communicate data to the first controller 504a commanding or instructing the first controller 504a to change or maintain a tint of the first smart glass unit 506a while allocating power to the first controller 504a to change or maintain the tint of the first smart glass unit 506a. Similarly, the central controller 505 may communicate data to the fifth controller 504e commanding or instructing the fifth controller 504e to change or maintain a tint of the fifth smart glass unit 506e while allocating power to the fifth controller 504e to change or maintain the tint of the fifth smart glass unit 506e. It should be understood that, while the examples provided herein relate to data communication between the central controller 505 and the first controller 504a and between the central controller 505 and the fifth controller 504e, the central controller 505 may communicate data to any one or more of the first controller 504a, the second controller 504b, the third controller 504c, the fourth controller 504d, the fifth controller 504e, and/or the sixth controller 504f, as described above.

The central controller 505 may receive data from each of the controllers to determine whether enough power is available from the power source 503 to change or maintain tinting of one or more smart glass units and/or to determine a speed by which a tinting of one or more smart glass units may change. For example, the central controller 505 may receive data from the controllers indicating that none of the smart glass units associated with the controllers are being tinted or are changing tint. The central controller 505, via the switch 502, may receive an external signal from a light sensor (not shown), a human interface device (not shown) command signal, or an external signal indicative of a preset timing schedule for maintaining and/or modifying tint indicated that one smart glass unit is to increase tinting. Based on the data received from the controllers, the central controller 505 may determine that there is enough power to increase tinting for the one smart glass unit and how fast the one smart glass unit can increase its tint. As another example, the central controller 505 may receive data from the controllers indicating that all of the smart glass units associated with the controllers are being tinted or are changing tint. The central controller 505 may receive an external signal from a light sensor (not shown), a human interface device (not shown) command signal, or an external signal indicative of a preset timing schedule for maintaining and/or modifying tint indicating that one smart glass unit is to increase tinting. Based on the data received from the controllers, the central controller 505 may determine that there is enough power to increase tinting for the one smart glass unit, but that the one smart glass unit is to increase its respective tint at a relatively slower rate in order to not exceed the available power. As yet another example, the central controller 505 may receive data from the controllers indicating that all of the smart glass units associated with the controllers are being tinted or are changing tint. The central controller 505 may receive, via the switch 502, an external signal from a light sensor (not shown), a human interface device (not shown) command signal, or an external signal indicative of a preset timing schedule for maintaining and/or modifying tint indicating that a smart glass unit is to increase tinting. Based on the data received from the controllers, the central controller 505 may determine that there is not enough power to increase tinting for the smart glass unit. The central controller 505 may abstain from increasing the tint of the smart glass unit until enough power is available or until another external signal is received providing one or more different commands.

In some aspects, the central controller 505 may monitor and/or be aware of known power levels in the system 500. For example, due to an abundance of power from the power source 503, the central controller 505 may assume that sufficient power is available to power the smart glass units of the system 500. Thus, the central controller 505 may determine whether or not to provide power to controllers and respective smart glass units to change or maintain a tint without receiving data from the plurality of controllers indicating a current tinting state. It should also be understood that each port of the switch 502 for respective controllers may have a power limit. For example, a large smart glass unit may use up to 10 W to change tint while the switch may handle up to 100 W. However, a port of the switch associated with the large glass unit may handle no more than 5 W. Thus, a controller (e.g., a central controller, a controller associated with the large smart glass unit) may slow down the tint speed to accommodate the available power at the port.

Additionally, or alternatively, the plurality of controllers may communicate data (e.g., control commands) between each other, via the switch 502, the respective sets of the single pair of wires for allocating power to the respective smart glass units. For example, the first controller 504a may receive power from the power source 503 via the switch 502 and the first set of the single pair of wires 501a. The second controller 504b may receive power from the power source 503 via the switch 502 and the second set of the single pair of wires 501b. The third controller 504c may receive power from the power source 503 via the switch 502 and the third set of the single pair of wires 501c. The fourth controller 504d may receive power from the power source 503 via the switch 502 and the fourth set of the single pair of wires 501d. The fifth controller 504e may receive power from the power source 503 via the switch 502 and the fifth set of the single pair of wires 501e. The sixth controller 504f may receive power from the power source 503 via the switch 502 and the sixth set of the single pair of wires 501f. The respective controllers may allocate power to the respective smart glass units to change or maintain tinting of those respective units.

The respective controllers may also transmit the data between each other to determine whether enough power is available from the power source 503 to change or maintain tinting of one or more smart glass units and/or to determine a speed by which a tinting of one or more smart glass units may change. For example, at least one controller may receive data from the remaining controllers indicating that none of the smart glass units associated with the remaining controllers are being tinted or are changing tint. The one controller may receive from the central controller 505, via the switch 502, an external signal from a light sensor (not shown), a human interface device (not shown) command signal, or an external signal indicative of a preset timing schedule for maintaining and/or modifying tint that the respective smart glass unit is to increase tinting. Based on the data received from the remaining controllers, the one controller may determine that there is enough power to increase tinting for the respective smart glass unit and how fast the respective smart glass unit can increase its tint. As another example, the one controller may receive data from the remaining controllers indicating that all of the smart glass units associated with the remaining controllers are being tinted or are changing tint. The one controller may receive from the central controller 505, via the switch 502, an external signal from a light sensor (not shown), a human interface device (not shown) command signal, or an external signal indicative of a preset timing schedule for maintaining and/or modifying tint that the respective smart glass unit is to increase tinting. Based on the data received from the remaining controllers, the one controller may determine that there is enough power to increase tinting for the respective smart glass unit, but that the respective smart glass unit is to increase its respective tint at a relatively slower rate in order to not exceed the available power. As yet another example, the one controller may receive data from the remaining controllers indicating that all of the smart glass units associated with the remaining controllers are being tinted or are changing tint. The one controller may receive from the central controller 505, via the switch 502, an external signal from a light sensor (not shown), a human interface device (not shown) command signal, or an external signal indicative of a preset timing schedule for maintaining and/or modifying tint that the smart glass unit associated with the one controller is to increase tinting. Based on the data received from the remaining controllers, the one controller may determine that there is not enough power to increase tinting for the respective smart glass unit. The one controller may abstain from increasing the tint of the respective smart glass unit until enough power is available or until another external signal is received providing one or more different commands.

FIG. 6 illustrates a block diagram of an example system 600 according to some aspects of this disclosure. The system 600 may include one or more same or similar features as the features described with respect to or illustrated in FIGS. 1, 2, 3, 4, 5, 7, 8, and 9. For example, the system 600 may include one or more same or similar features as the features described with respect to the EC system 100 described with respect to FIG. 1, the system 200 described with respect to FIG. 2, the smart glass unit system 400 described with respect to FIG. 4, the system 500 described with respect to FIG. 5, the system 700 described with respect to FIG. 7, and the method 800 described with respect to FIG. 8, and/or the computer system 900 described with respect to FIG. 9. The system 600 may utilize and/or include the single pair cable 300 and/or the set of the single pair of wires 302 illustrated in FIG. 3. FIG. 6, as with the other included figures, is shown for illustrative purposes and does not limit either the possible embodiments of the present invention or the claims.

As shown in FIG. 6, the system 600 includes a switch 602 (e.g., a POE or powered switch), a power source 603, a central controller 605, a plurality of controllers, a plurality of smart glass units, a plurality of sets of the single pair of wires (e.g., set of the single pair of wires 302 illustrated in FIG. 3). The power source 603 may be configured to provide power (e.g., alternating current (AC) power) through the switch 602 to a first controller 604a via a first set of the single pair of wires 601a, to a second controller 604b via a second set of the single pair of wires 601b connecting the first controller 604a to the second controller 604b, to a third controller 604c via a third set of the single pair of wires 601c connecting the second controller 604b to the third controller 604c, to a fourth controller 604d via a fourth set of the single pair of wires 601d connecting the third controller 604c to the fourth controller 604d, to a fifth controller 604e via a fifth set of the single pair of wires 601e connecting the fourth controller 604d to the fifth controller 604e, to a sixth controller 604f via a sixth set of the single pair of wires 601f connecting the fifth controller 604e to the sixth controller 604f. The sixth controller 604f may be connected to the switch 602 via seventh set of the single pair of wires 601g. This configuration comprises a daisy-chain configuration formed by the single pair of wires connecting controllers of respective smart glass units together.

It should be understood that available power for respective smart glass units may decrease along the daisy-chain. For example, the available power for the first smart glass unit 604a may be greater than the available power for the second smart glass unit 604b. Similarly, the available power for the second smart glass unit 604b may be greater than the available power for the third smart glass unit 604c. Further, the available power for the third smart glass unit 604c may be greater than the available power for the fourth smart glass unit 604d. In addition, the available power for the fourth smart glass unit 604d may be greater than the available power for the fifth smart glass unit 604c. Also, the available power for the fifth smart glass unit 604e may be greater than the available power for the sixth smart glass unit 604f. When allocating power to the respective smart glass units, the respective controllers should account for the diminishing available power for each respective smart glass unit progressing along the daisy chain away from the power source 603 and the switch 602.

In some aspects, the power source 603 may provide sufficient power (e.g., more than sufficient power) to power all the smart glass units. In this case, the controllers associated with the respective smart glass units may receive signal(s) from the central controller 605 to maintain or change tint. The respective controllers may implement instructions from the central controller 605 via the signal(s) to maintain or change tint without conducting their own respective analysis.

Respective controllers may be electrically connected to respective smart glass units in order to change or maintain a tint of respective smart glass units. For example, a first controller 604a may be electrically connected to the first smart glass unit 606a, the second controller 604b may be electrically connected to the second smart glass unit 606b, the third controller 604c may be electrically connected to the third smart glass unit 606c, the fourth controller 604d may be electrically connected to the fourth smart glass unit 606d, the fifth controller 604e may be electrically connected to the fifth smart glass unit 606e, and the sixth controller 604f may be electrically connected to the sixth smart glass unit 606f.

The power source 603 may be configured to provide power (e.g., alternating current (AC) power), via the switch 602, to the system 600. The central controller 605 may control the supply of power to a plurality of controllers for changing and/or maintaining a tint of respective smart glass units. For example, the central controller 605 may control the supply of power to the first controller 604a via the switch 602 and the first set of the single pair of wires 601a, from the first controller 604a to the second controller 604b via the second set of the single pair of wires 601b, from the second controller 604b to the third controller 604c via the third set of the single pair of wires 601c, from the third controller 604c to the fourth controller 604d via the fourth set of the single pair of wires 601d, from the fourth controller 604d to the fifth controller 604e via the fifth set of the single pair of wires 601e, and from the fifth controller 604e to the sixth controller 604f via the sixth set of the single pair of wires 601f. Using the power allocated by the central controller 605 to the plurality of controllers, the controllers may provide power to the smart glass units. For example, the first controller 604a may provide power to the first smart glass unit 606a, the second controller 604b may provide power to the second smart glass unit 606b, the third controller 604c may provide power to the third smart glass unit 606c, the fourth controller 604d may provide power to the fourth smart glass unit 606d, the fifth controller 604e may provide power to the fifth smart glass unit 606e, the sixth controller 604f may provide power to the sixth smart glass unit 606f.

The central controller 605 may also communicate data (e.g., control commands) to the first controller 604a, the second controller 604b, the third controller 604c, the fourth controller 604d, the fifth controller 604e, and the sixth controller 604f so that the respective controllers may allocate power to the respective smart glass units. For example, the central controller 605 may communicate data to the first controller 604a commanding or instructing the first controller 604a to change or maintain a tint of the first smart glass unit 606a while allocating power to the first controller 604a to change or maintain the tint of the first smart glass unit 606a. Similarly, the central controller 605 may communicate data to the fifth controller 604e commanding or instructing the fifth controller 604e to change or maintain a tint of the fifth smart glass unit 606e while allocating power to the fifth controller 604e to change or maintain the tint of the fifth smart glass unit 606e. It should be understood that, while the examples provided herein relate to data communication between the central controller 605 and the first controller 604a and between the central controller 605 and the fifth controller 604e, the central controller 605 may communicate data to any one or more of the first controller 604a, the second controller 604b, the third controller 604c, the fourth controller 604d, the fifth controller 604e, and/or the sixth controller 604f, as described above.

The central controller 605 may receive data from each of the controllers to determine whether enough power is available from the power source 603 to change or maintain tinting of one or more smart glass units and/or to determine a speed by which a tinting of one or more smart glass units may change. For example, the central controller 605 may receive data from the controllers indicating that none of the smart glass units associated with the controllers are being tinted or are changing tint. The central controller 605, via the switch 602, may receive an external signal from a light sensor (not shown), a human interface device (not shown) command signal, or an external signal indicative of a preset timing schedule for maintaining and/or modifying tint indicated that one smart glass unit is to increase tinting. Based on the data received from the controllers, the central controller 605 may determine that there is enough power to increase tinting for the one smart glass unit and how fast the one smart glass unit can increase its tint. As another example, the central controller 605 may receive data from the controllers indicating that all of the smart glass units associated with the controllers are being tinted or are changing tint. The central controller 605 may receive an external signal from a light sensor (not shown), a human interface device (not shown) command signal, or an external signal indicative of a preset timing schedule for maintaining and/or modifying tint indicating that one smart glass unit is to increase tinting. Based on the data received from the controllers, the central controller 605 may determine that there is enough power to increase tinting for the one smart glass unit, but that the one smart glass unit is to increase its respective tint at a relatively slower rate in order to not exceed the available power. As yet another example, the central controller 605 may receive data from the controllers indicating that all of the smart glass units associated with the controllers are being tinted or are changing tint. The central controller 605 may receive, via the switch 602, an external signal from a light sensor (not shown), a human interface device (not shown) command signal, or an external signal indicative of a preset timing schedule for maintaining and/or modifying tint indicating that a smart glass unit is to increase tinting. Based on the data received from the controllers, the central controller 605 may determine that there is not enough power to increase tinting for the smart glass unit. The central controller 605 may abstain from increasing the tint of the smart glass unit until enough power is available or until another external signal is received providing one or more different commands.

In some aspects, the central controller 605 may monitor and/or be aware of known power levels in the system 600. For example, due to an abundance of power from the power source 603, the central controller 605 may assume that sufficient power is available to power the smart glass units of the system 600. Thus, the central controller 605 may determine whether or not to provide power to controllers and respective smart glass units to change or maintain a tint without receiving data from the plurality of controllers indicating a current tinting state. It should also be understood that each port of the switch 602 for respective controllers may have a power limit. For example, a large smart glass unit may use up to 10 W to change tint while the switch may handle up to 100 W. However, a port of the switch associated with the large glass unit may handle no more than 5 W. Thus, a controller (e.g., a central controller, a controller associated with the large smart glass unit) may slow down the tint speed to accommodate the available power at the port.

Additionally, or alternatively, the plurality of controllers may communicate data (e.g., control commands) between each other, via the switch 602 and the daisy-chain of sets of the single pair of wires, for allocating power to the respective smart glass units. For example, the first controller 604a may receive power from the power source 603 via the switch 602 and the first set of the single pair of wires 601a. The second controller 604b may receive power from the power source 603 via the switch 602, the first set of single pairs wires 601a, and the second set of the single pair of wires 601b. The third controller 604c may receive power from the power source 603 via the switch 602, the first set of single pairs wires 601a, the second set of the single pair of wires 601b, and the third set of the single pair of wires 601c. The fourth controller 604d may receive power from the power source 603 via the switch 602, the first set of single pairs wires 601a, the second set of the single pair of wires 601b, the third set of the single pair of wires 601c, and the fourth set of the single pair of wires 601d. The fifth controller 604e may receive power from the power source 603 via the switch 602, the first set of single pairs wires 601a, the second set of the single pair of wires 601b, the third set of the single pair of wires 601c, the fourth set of the single pair of wires 601d, and the fifth set of the single pair of wires 601e. The sixth controller 604f may receive power from the power source 603 via the switch 602, the first set of single pairs wires 601a, the second set of the single pair of wires 601b, the third set of the single pair of wires 601c, the fourth set of the single pair of wires 601d, the fifth set of the single pair of wires 601e, and the sixth set of the single pair of wires 601f. The respective controllers may allocate power to the respective smart glass units to change or maintain tinting of those respective units.

The respective controllers may also transmit the data between each other to determine whether enough power is available from the power source 603 to change or maintain tinting of one or more smart glass units and/or to determine a speed by which a tinting of one or more smart glass units may change. For example, at least one controller may receive data from the remaining controllers indicating that none of the smart glass units associated with the remaining controllers are being tinted or are changing tint. The one controller may receive from the central controller 605, via the switch 602, an external signal from a light sensor (not shown), a human interface device (not shown) command signal, or an external signal indicative of a preset timing schedule for maintaining and/or modifying tint that the respective smart glass unit is to increase tinting. Based on the data received from the remaining controllers, the one controller may determine that there is enough power to increase tinting for the respective smart glass unit and how fast the respective smart glass unit can increase its tint. As another example, the one controller may receive data from the remaining controllers indicating that all of the smart glass units associated with the remaining controllers are being tinted or are changing tint. The one controller may receive from the central controller 605, via the switch 602, an external signal from a light sensor (not shown), a human interface device (not shown) command signal, or an external signal indicative of a preset timing schedule for maintaining and/or modifying tint that the respective smart glass unit is to increase tinting. Based on the data received from the remaining controllers, the one controller may determine that there is enough power to increase tinting for the respective smart glass unit, but that the respective smart glass unit is to increase its respective tint at a relatively slower rate in order to not exceed the available power. As yet another example, the one controller may receive data from the remaining controllers indicating that all of the smart glass units associated with the remaining controllers are being tinted or are changing tint. The one controller may receive from the central controller 605, via the switch 602, an external signal from a light sensor (not shown), a human interface device (not shown) command signal, or an external signal indicative of a preset timing schedule for maintaining and/or modifying tint that the smart glass unit associated with the one controller is to increase tinting. Based on the data received from the remaining controllers, the one controller may determine that there is not enough power to increase tinting for the respective smart glass unit. The one controller may abstain from increasing the tint of the respective smart glass unit until enough power is available or until another external signal is received providing one or more different commands.

In some aspects, the system 600 may include fuses positioned with each of the respective controllers and/or the respective smart glass units. Each of the fuse ratings may be manually set from a selection switch or a selectable jumper. In some aspects, each of the fuse ratings may be set through software settings (e.g., Flash/EEPROM variable) in the respective controllers or the central controller 605. In some aspects, the respective controllers and/or the central controller 605 may determine the quantity of connected smart glass units in the system 600 and their power ratings downstream. The respective controllers and/or the central controller 605 may determine the respective fuse rating for each of the smart glass units or smart glass unit systems based on the number of smart glass units and/or the downstream power rating of the respective smart glass units. For example, upon startup or power on of the system, upon adding a new controller to the system, upon removing a controller from the system, and/or upon rearranging a controller within the system, the central controller 605 (and/or each individual controller) may communicate with the other controllers within the system and identify each of their respective positions relative to each other along the daisy chain and the number of controllers positioned along the daisy chain. A fuse rating for each of the controllers may be automatically set by the central controller 605 (or the respective individual controllers) based on the respective relative positions of the controllers and the identified number of controllers. This may allow the system to automatically change the respective fuse ratings for each of the controllers when one or more controllers are added to the system, removed from the system, and/or rearranged within the system.

FIG. 7 illustrates a block diagram of an example system 700 according to some aspects of this disclosure. The system 700 may include one or more same or similar features as the features described with respect to or illustrated in FIGS. 1, 2, 3, 4, 5, 6, 8, and 9. For example, the system 700 may include one or more same or similar features as the features described with respect to the EC system 100 described with respect to FIG. 1, the system 200 described with respect to FIG. 2, the smart glass unit system 400 described with respect to FIG. 4, the system 500 described with respect to FIG. 5, the system 600 described with respect to FIG. 6, the method 800 described with respect to FIG. 8, and/or the computer system 900 described with respect to FIG. 9. The system 700 may utilize and/or include the single pair cable 300 and/or the set of the single pair of wires 302 illustrated in FIG. 3. FIG. 7, as with the other included figures, is shown for illustrative purposes and does not limit either the possible embodiments of the present invention or the claims.

As shown in FIG. 7, the system 700 includes a switch 702 (e.g., a POE or powered switch), a power source 703, a central controller 705, a plurality of controllers, a plurality of smart glass units, a plurality of sets of the single pair of wires (e.g., set of the single pair of wires 302 illustrated in FIG. 3). The power source 703 may be configured to provide power (e.g., alternating current (AC) power) through the switch 702 to the plurality of controllers via the bus 701g and the single pairs of wires for the respective controllers. For example, the power source 703 may be configured to provide power (e.g., alternating current (AC) power) through the switch 702, via the bus 701g, to a first controller 704a via a first set of the single pair of wires 701a, to a second controller 704b via a second set of the single pair of wires 701b connecting the first controller 704a to the second controller 704b, to a third controller 704c via a third set of the single pair of wires 701c connecting the second controller 704b to the third controller 704c, to a fourth controller 704d via a fourth set of the single pair of wires 701d connecting the third controller 704c to the fourth controller 704d, to a fifth controller 704e via a fifth set of the single pair of wires 701e connecting the fourth controller 704d to the fifth controller 704e, to a sixth controller 704f via a sixth set of the single pair of wires 701f connecting the fifth controller 704e to the sixth controller 704f. The sixth controller 704f may be connected to the switch 702 via seventh set of the single pair of wires 701g. This configuration comprises a dropline configuration formed by the single pair of wires connecting controllers of respective smart glass units together via a bus 701g. The bus 701g may include the single pair of wires. In some aspects and as shown FIG. 7, the bus 701g may extend from the switch 702 without returning (e.g., in a loop configuration) to the switch 702.

It should be understood that total power per smart glass unit in the system 700 may change as the number of nodes (e.g., and thus smart glass units) of the system 700 changes. Thus, the greater the amount of smart glass units connected to the bus 701g, the less power is available per smart glass unit. Conversely, the lesser the amount of smart glass units connected to the bus 701g, the more power is available per smart glass unit.

Respective controllers may be electrically connected to respective smart glass units in order to change or maintain a tint of respective smart glass units. For example, a first controller 704amay be electrically connected to the first smart glass unit 706a, the second controller 704b may be electrically connected to the second smart glass unit 706b, the third controller 704c may be electrically connected to the third smart glass unit 706c, the fourth controller 704d may be electrically connected to the fourth smart glass unit 706d, the fifth controller 704e may be electrically connected to the fifth smart glass unit 706e, and the sixth controller 704f may be electrically connected to the sixth smart glass unit 706f.

The power source 703 may be configured to provide power (e.g., alternating current (AC) power), via the switch 702 and the bus 701g, to the system 700. The central controller 705 may control the supply of power to a plurality of controllers for changing and/or maintaining a tint of respective smart glass units. For example, the central controller 705 may control the supply of power to the first controller 704a via the switch 702, the bus 701g, and the first set of the single pair of wires 701a, to the second controller 704b via the switch 702, the bus 701g, and the second set of the single pair of wires 701b, to the third controller 704c via the switch 702, the bus 701g, and the third set of the single pair of wires 701c, to the fourth controller 704d via the switch 702, the bus 701g, and the fourth set of the single pair of wires 701d, to the fifth controller 704e via the switch 702, the bus 701g, and the fifth set of the single pair of wires 701e, and to the sixth controller 704f via the switch 702, the bus 701g, and the sixth set of the single pair of wires 701f. Using the power allocated by the central controller 705 to the plurality of controllers, the controllers may provide power to the smart glass units. For example, the first controller 704a may provide power to the first smart glass unit 706a, the second controller 704b may provide power to the second smart glass unit 706b, the third controller 704c may provide power to the third smart glass unit 706c, the fourth controller 704d may provide power to the fourth smart glass unit 706d, the fifth controller 704e may provide power to the fifth smart glass unit 706e, the sixth controller 704f may provide power to the sixth smart glass unit 706f.

The central controller 705 may also communicate data (e.g., control commands) to the first controller 704a, the second controller 704b, the third controller 704c, the fourth controller 704d, the fifth controller 704e, and the sixth controller 704f so that the respective controllers may allocate power to the respective smart glass units. For example, the central controller 705 may communicate data to the first controller 704a commanding or instructing the first controller 704a to change or maintain a tint of the first smart glass unit 706a while allocating power to the first controller 704a to change or maintain the tint of the first smart glass unit 706a. Similarly, the central controller 705 may communicate data to the fifth controller 704e commanding or instructing the fifth controller 704e to change or maintain a tint of the fifth smart glass unit 706e while allocating power to the fifth controller 704e to change or maintain the tint of the fifth smart glass unit 706e. It should be understood that, while the examples provided herein relate to data communication between the central controller 705 and the first controller 704a and between the central controller 705 and the fifth controller 704c, the central controller 705 may communicate data to any one or more of the first controller 704a, the second controller 704b, the third controller 704c, the fourth controller 704d, the fifth controller 704c, and/or the sixth controller 704f, as described above.

The central controller 705 may receive data from each of the controllers to determine whether enough power is available from the power source 703 to change or maintain tinting of one or more smart glass units and/or to determine a speed by which a tinting of one or more smart glass units may change. For example, the central controller 705 may receive data from the controllers indicating that none of the smart glass units associated with the controllers are being tinted or are changing tint. The central controller 705, via the switch 702, may receive an external signal from a light sensor (not shown), a human interface device (not shown) command signal, or an external signal indicative of a preset timing schedule for maintaining and/or modifying tint indicated that one smart glass unit is to increase tinting. Based on the data received from the controllers, the central controller 705 may determine that there is enough power to increase tinting for the one smart glass unit and how fast the one smart glass unit can increase its tint. As another example, the central controller 705 may receive data from the controllers indicating that all of the smart glass units associated with the controllers are being tinted or are changing tint. The central controller 705 may receive an external signal from a light sensor (not shown), a human interface device (not shown) command signal, or an external signal indicative of a preset timing schedule for maintaining and/or modifying tint indicating that one smart glass unit is to increase tinting. Based on the data received from the controllers, the central controller 705 may determine that there is enough power to increase tinting for the one smart glass unit, but that the one smart glass unit is to increase its respective tint at a relatively slower rate in order to not exceed the available power. As yet another example, the central controller 705 may receive data from the controllers indicating that all of the smart glass units associated with the controllers are being tinted or are changing tint. The central controller 705 may receive, via the switch 702, an external signal from a light sensor (not shown), a human interface device (not shown) command signal, or an external signal indicative of a preset timing schedule for maintaining and/or modifying tint indicating that a smart glass unit is to increase tinting. Based on the data received from the controllers, the central controller 705 may determine that there is not enough power to increase tinting for the smart glass unit. The central controller 705 may abstain from increasing the tint of the smart glass unit until enough power is available or until another external signal is received providing one or more different commands.

In some aspects, the central controller 705 may monitor and/or be aware of known power levels in the system 700. For example, due to an abundance of power from the power source 703, the central controller 705 may assume that sufficient power is available to power the smart glass units of the system 700. Thus, the central controller 705 may determine whether or not to provide power to controllers and respective smart glass units to change or maintain a tint without receiving data from the plurality of controllers indicating a current tinting state. It should also be understood that each port of the switch 702 for respective controllers may have a power limit. For example, a large smart glass unit may use up to 10 W to change tint while the switch may handle up to 100 W. However, a port of the switch associated with the large glass unit may handle no more than 5 W. Thus, a controller (e.g., a central controller, a controller associated with the large smart glass unit) may slow down the tint speed to accommodate the available power at the port.

The plurality of controllers may also communicate data (e.g., control commands) between each other, via the switch 702, the sets of the single pair of wires, and the bus 701g, for allocating power to the respective smart glass units. For example, the first controller 704a may receive power from the power source 703 via the switch 702, the bus 701g, and the first set of the single pair of wires 701a. The second controller 704b may receive power from the power source 703 via the switch 702, the bus 701g, and the second set of the single pair of wires 701b. The third controller 704c may receive power from the power source 703 via the switch 702, the bus 701g, and the third set of the single pair of wires 701c. The fourth controller 704d may receive power from the power source 703 via the switch 702, the bus 701d, and the fourth set of the single pair of wires 701d. The fifth controller 704e may receive power from the power source 703 via the switch 702, the bus 701g, and the fifth set of the single pair of wires 701e. The sixth controller 704f may receive power from the power source 703 via the switch 702, the bus 701g, and the sixth set of the single pair of wires 701f. The respective controllers may allocate power to the respective smart glass units to change or maintain tinting of those respective units.

The respective controllers may also transmit the data between each other to determine whether enough power is available from the power source 703 to change or maintain tinting of one or more smart glass units and/or to determine a speed by which a tinting of one or more smart glass units may change. For example, at least one controller may receive data from the remaining controllers indicating that none of the smart glass units associated with the remaining controllers are being tinted or are changing tint. The one controller may receive from the central controller 705, via the switch 702, an external signal from a light sensor (not shown), a human interface device (not shown) command signal, or an external signal indicative of a preset timing schedule for maintaining and/or modifying tint that the respective smart glass unit is to increase tinting. In some aspect, external signals and/or command signals, as described herein, may bypass the central controller 705 and may be received directly by the one controller (e.g., the individual controllers). Based on the data received from the remaining controllers, the one controller may determine that there is enough power to increase tinting for the respective smart glass unit and how fast the respective smart glass unit can increase its tint. As another example, the one controller may receive data from the remaining controllers indicating that all of the smart glass units associated with the remaining controllers are being tinted or are changing tint. The one controller may receive from the central controller 705, via the switch 702, an external signal from a light sensor (not shown), a human interface device (not shown) command signal, or an external signal indicative of a preset timing schedule for maintaining and/or modifying tint that the respective smart glass unit is to increase tinting. Based on the data received from the remaining controllers, the one controller may determine that there is enough power to increase tinting for the respective smart glass unit, but that the respective smart glass unit is to increase its respective tint at a relatively slower rate in order to not exceed the available power. As yet another example, the one controller may receive data from the remaining controllers indicating that all of the smart glass units associated with the remaining controllers are being tinted or are changing tint. The one controller may receive from the central controller 705, via the switch 702, an external signal from a light sensor (not shown), a human interface device (not shown) command signal, or an external signal indicative of a preset timing schedule for maintaining and/or modifying tint that the smart glass unit associated with the one controller is to increase tinting. Based on the data received from the remaining controllers, the one controller may determine that there is not enough power to increase tinting for the respective smart glass unit. The one controller may abstain from increasing the tint of the respective smart glass unit until enough power is available or until another external signal is received providing one or more different commands.

FIG. 8 illustrates a block diagram of an example method 800 according to some aspects of this disclosure. The method 800 may include and/or may be implemented using one or more same or similar features as the features described with respect to or illustrated in FIGS. 1, 2, 3, 4, 5, 6, 7, and 9. For example, the method 800 may be implemented in the EC system 100 described with respect to FIG. 1, the system 200 described with respect to FIG. 2, the smart glass unit system 400 described with respect to FIG. 4, the system 500 described with respect to FIG. 5, the system 600 described with respect to FIG. 6, the system 700 described with respect to FIG. 7, and/or the computer system 900 described with respect to FIG. 9. FIG. 8, as with the other included figures, is shown for illustrative purposes and does not limit either the possible embodiments of the present invention or the claims.

At step 801, a controller (e.g., a controller associated with one or more smart glass units, a central controller) may receive data, over the single pair of wires, from one or more other controllers concerning one or more tinting states of a plurality of smart glass units. For example, the controller may receive, over the single pair of wires, information concerning whether a plurality of respective smart glass units is maintaining a particular amount of tint and/or whether the plurality of respective smart glass units is increasing or decreasing an amount of tint.

At step 803, the controller may receive one or more control commands over the single pair of wires indicating that a particular smart glass unit is to change or maintain a particular tinting level and/or implement a particular rate of tint change. For example, the controller may receive a control command based on an external signal from a light sensor indicating whether the particular smart glass unit is to change or maintain a particular tinting level and/or implement a particular rate of tint change. As another example, the controller may determine a control command indicative of a state for the particular smart glass unit based on a preset timing schedule for maintaining and/or modifying tint or a received control command from another controller indicative of a preset timing schedule for maintaining and/or modifying tint. As another example, the controller may receive a control command based on a signal from a human via a human interface indicating whether the particular smart glass unit is to change or maintain a particular tinting level and/or implement a particular rate of tint change.

At step 805, the controller may determine an amount of power available for changing or maintaining a tint of the particular smart glass unit. For example, the controller may receive, over the single pair of wires, data from one or more other controllers indicating the state of other associated smart glass units. For example, the controller may receive, over the single pair of wires, data from a plurality of different controllers indicating tinting states or tinting changes for respective smart glass units. Based on a total available amount of power from a power source over the single pair of wires and a determined amount of utilized power from the states of the respective smart glass units, the controller may determine an amount of power available for changing or maintaining a tint of the particular smart glass unit.

At step 807, the controller may determine whether to change or maintain the state of the particular smart glass unit based on the amount of power available for changing or maintaining a tint of the particular smart glass unit and/or based on one or more control commands. For example, the controller may receive data from other controllers indicating that none of the smart glass units associated with the remaining controllers are being tinted or are changing tint. The one controller may receive from the central controller 705, via the switch 702, a control command based on an external signal generated from a light sensor (not shown) or a control command from an external signal indicative of a preset timing schedule for maintaining and/or modifying tint indicating that the respective smart glass unit is to increase tinting. Based on the data received from the remaining controllers and the control command, the one controller may determine that there is enough power to increase tinting for the respective smart glass unit and how fast the respective smart glass unit can increase its tint. As another example, the controller may receive data from the other controllers indicating that all of the smart glass units associated with the other controllers are being tinted or are changing tint. The controller may receive from the central controller 705, via the switch 702, a control command based on an external signal from a light sensor (not shown), a human interface device (not shown) command signal, or a control command from an external signal indicative of a preset timing schedule for maintaining and/or modifying tint indicating that the respective smart glass unit is to increase tinting. Based on the data received from the other controllers and the control command, the controller may determine that there is enough power to increase tinting for the respective smart glass unit, but that the respective smart glass unit is to increase its respective tint at a relatively slower rate in order to not exceed the available power. As yet another example, the controller may receive data from the other controllers indicating that all of the smart glass units associated with the other controllers are being tinted or are changing tint. The controller may receive from the central controller 705, via the switch 702, a control command based on an external signal from a light sensor (not shown), a human interface device (not shown) command signal, or a control command from an external signal indicative of a preset timing schedule for maintaining and/or modifying tint indicating that the smart glass unit associated with the controller is to increase tinting. Based on the data received from the other controllers and the control command, the controller may determine that there is not enough power to increase tinting for the respective smart glass unit. The controller may abstain from increasing the tint of the respective smart glass unit until enough power is available or until another control command is received providing one or more different commands. At step 809, the controller updates a state of the particular smart glass unit based on determining whether to change or maintain the state of the particular smart glass unit. For example, the controller may increase the tint of the smart glass unit at a particular tinting rate, decrease the tint of the smart glass unit at a particular tinting rate, or maintain a level of tint of the smart glass unit.

FIG. 9 illustrates an example computer system 900 that may be used in some embodiments. The methods, features, mechanisms, techniques and/or functionality described herein may in various embodiments be implemented by any combination of hardware and software. For example, in one embodiment, the methods may be implemented by a computer system (e.g., a computer system as in FIG. 9) that includes one or more processors executing program instructions stored on a computer-readable storage medium coupled to the processors. The program instructions may implement the methods, features, mechanisms, techniques and/or functionality described herein. The various methods as illustrated in the figures and described herein represent example embodiments of methods. The order of any method may be changed, and various elements may be added, reordered, combined, omitted, modified, etc.

FIG. 9 is a block diagram illustrating a computer system 900 according to some aspects, as well as various other systems, components, services or devices described herein. The computer system 900, for example, may be included in the controller and/or central controllers described herein with respect to FIGS. 1, 2, 4, 5, 6, 7, and 8 as well as a combination one or more steps from any of the methods described herein. For example, computer system 900 may implement a control unit configured to implement and/or utilize the features, methods, mechanisms and/or techniques described herein, in different embodiments. Computer system 900 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 900 includes one or more processors 910 (any of which may include multiple cores, which may be single or multi-threaded) coupled to a system memory 920 via an input/output (I/O) interface 930. Computer system 900 further includes a network interface 940 coupled to I/O interface 930. In various embodiments, computer system 900 may be a uniprocessor system including one processor 910, or a multiprocessor system including several processors 910 (e.g., two, four, eight, or another suitable number). Processors 910 may be any suitable processors capable of executing instructions. For example, in various embodiments, processors 910 may be general-purpose or embedded processors implementing any of a variety of instruction set architectures (ISAs), such as the x86, PowerPC, SPARC, or MIPS ISAs, or any other suitable ISA. In multiprocessor systems, each of processors 910 may commonly, but not necessarily, implement the same ISA. The computer system 900 also includes one or more network communication devices (e.g., network interface 940) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote-control device (e.g., a remote control), a wall mounted (e.g., hard wired) device, or an application executing on any of various types of devices (e.g., a portable phone, smart phone, tablet and/or desktop computer are just a few examples).

In the illustrated embodiment, computer system 900 is coupled to one or more portable storage devices 980 via device interface 970. In various embodiments, portable storage devices 980 may correspond to disk drives, tape drives, solid state memory, other storage devices, or any other persistent storage device. Computer system 900 (or a distributed application or operating system operating thereon) may store instructions and/or data in portable storage devices 980, as desired, and may retrieve the stored instruction and/or data as needed. In some embodiments, portable device(s) 980 may store information regarding one or EC devices, such as information regarding design parameters, etc. usable by control unit 320 when changing tint levels using the techniques described herein.

Computer system 900 includes one or more system memories 920 that can store instructions and data accessible by processor(s) 910. In various embodiments, system memories 920 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 920 may contain program instructions 925 that are executable by processor(s) 910 to implement the methods and techniques described herein. In various embodiments, program instructions 925 may be encoded in platform native binary, any interpreted language such as Java™ bytecode, or in any other language such as C/C++, Java™, etc., or in any combination thereof. For example, in the illustrated embodiment, program instructions 925 include program instructions executable to implement the functionality of a control unit, a stack voltage measurement module, an ESR module, an OCV module, a supervisory control system, local controller, project database, etc., in different embodiments. In some embodiments, program instructions 925 may implement a control unit configured to implement and/or utilize the features, methods, mechanisms and/or techniques described herein, and/or other components.

In some embodiments, program instructions 925 may include instructions executable to implement an operating system (not shown), which may be any of various operating systems, such as UNIX, LINUX, Solaris™, MacOS™, Windows™, etc. Any or all of program instructions 925 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 900 via I/O interface 930. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 900 as system memory 920 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 940.

In one embodiment, I/O interface 930 may coordinate I/O traffic between processor 910, system memory 920 and any peripheral devices in the system, including through network interface 940 or other peripheral interfaces, such as device interface 970. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments, some or all of the functionality of I/O interface 930, such as an interface to system memory 920, may be incorporated directly into processor 910.

Network interface 940 may allow data to be exchanged between computer system 900 and other devices attached to a network, such as other computer systems 960. In addition, network interface 940 may allow communication between computer system 900 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 900. Multiple input/output devices may be present in computer system 900 or may be distributed on various nodes of a distributed system that includes computer system 900. In some embodiments, similar input/output devices may be separate from computer system 900 and may interact with one or more nodes of a distributed system that includes computer system 900 through a wired or wireless connection, such as over network interface 940. Network interface 940 may commonly support one or more wireless networking protocols (e.g., Wi-Fi/IEEE 802.11, or another wireless networking standard). However, in various embodiments, network interface 940 may support communication via any suitable wired or wireless general data networks, such as other types of Ethernet networks, for example. Additionally, network interface 940 may support communication via telecommunications/telephony networks such as analog voice networks or digital fiber communications networks, via storage area networks such as Fibre Channel SANs, or via any other suitable type of network and/or protocol. In various embodiments, computer system 900 may include more, fewer, or different components than those illustrated in FIG. 9 (e.g., displays, video cards, audio cards, peripheral devices, other network interfaces such as an ATM interface, an Ethernet interface, a Frame Relay interface, etc.)

A system is provided. The system may include one or more smart glass units. The system may also include one or more controllers. A respective controller of the one or more controllers may include a connector configured to receive a single pair of wires. The respective controller of the one or more controllers may also include an interface to electrically connect to at least one smart glass unit of the one or more smart glass units. The respective controller of the one or more controllers may further include control circuitry configured to electrically control the at least one smart glass unit, via the interface, to change or maintain a tint of the at least one smart glass unit based on data received, via the connector, on the single pair of wires. The respective controller may be configured to receive power, via the connector, for powering the control circuitry and for powering the interface to the at least one smart glass unit on the same single pair of wires on which the data is received.

In some aspects, at least the respective controller of the one or more controllers may be configured to utilize a single-pair ethernet (SPE) and power over data line (PoDL) for receiving the data and the power over the single pair of wires. In some aspects, the respective controller may be a first controller, the connector is a first connector, the single pair of wires may be a first single pair of wires, the interface may be a first interface, the control circuitry may be a first control circuitry. The system may further include a second controller of the one or more controllers. The second controller may include a second connector configured to receive a second single pair of wires. The second controller may also include a second interface to electrically connect to at least one other smart glass unit of the one or more smart glass units. The second controller may further include a second control circuitry configured to electrically control the at least one other smart glass unit based on the data received, via the second connector, on the second single pair of wires. The second controller may configured to receive power, via the second connector, for powering the second control circuitry and for powering the second interface to the at least one other smart glass unit on the same second single pair of wires on which the data is received. In some aspects, the second single pair of wires may be electrically connected to the first single pair of wires via the first connector. In some aspects, the first control circuitry may be configured to determine whether to allocate, based on one or more control signals from the data received via the first single pair of wires, the power from the first single pair of wires to the at least one smart glass unit, via the first interface, to change or maintain a tint of the at least one smart glass unit, or the at least one other smart glass unit, via the second interface, for powering the second control circuitry and for powering the second interface to the at least one other smart glass unit on the same second single pair of wires on which the data is received.

In some aspects, the system further may further include another controller that is configured to determine a first amount of power for the at least one smart glass unit, via the first interface, to change or maintain a tint of the at least one smart glass unit, and determine a second amount of power for the at least one other smart glass unit, via the second connector, for powering the second control circuitry and for powering the second interface to the at least one other smart glass unit. In some aspects, the first single pair of wires may extend from the first controller, via the first connector, and may electrically connect the first controller to a bus. The second single pair of wires may extend from the second controller, via the second connector, and may electrically connect the second controller to the same bus. The bus may include another single pair of wires. The one or more controllers may further include a central controller in electrical communication, via a switch, with at least the respective controller via the single pair of wires. The central controller may be configured to transmit, via the single pair of wires and the switch, data to at least the respective controller to direct the respective controller to maintain or change tint of the at least one smart glass unit, and provide, via the single pair of wires and the switch, power to at least the respective controller to maintain or change the tint of the at least one smart glass unit.

A smart glass unit system is provided. The smart glass unit system may include a smart glass unit, a controller, and a single pair of wires extending from the controller. The single pair of wires may be configured to communicate power and data between the controller and at least one other controller of at least one other smart glass unit system. The controller may include a connector configured to receive the single pair of wires, an interface to electrically connect to the smart glass unit, and control circuitry configured to electrically control the smart glass unit via the interface to change or maintain a tint of the smart glass unit based on the data received, via the connector, on the single pair of wires. The controller may be configured to receive power on the same single pair of wires on which the data is received, via the connector, for powering the control circuitry, for powering the interface to the smart glass unit, and for providing power to the smart glass unit.

In some aspects, the controller may be configured to utilize a single-pair ethernet (SPE) and power over data line (PoDL) for receiving the data and the power over the single pair of wires. In some aspects, the controller may be further configured to receive power on the same single pair of wires on which the data is received, via the connector for providing power to the at least one other smart glass unit system. In some aspects, the smart glass unit may include an electrochromic (EC) device.

A method implemented by a controller for controlling at least one smart glass unit in a system is provided. The method may include receiving, by the controller over a single pair of wires and from another controller, data concerning a tinting state of another smart glass unit controlled by the other controller. The method may also include receiving, by the controller over the single pair of wires, one or more control commands indicating that the smart glass unit controlled by the controller is to change or maintain a tinting state. The method may further include determining, by the controller, an amount of power available over the single pair of wires for changing or maintaining the tinting state of the smart glass unit based on the data. In addition, the method may include updating, by the controller, the tint state of the smart glass unit based on the amount of available power over the single pair of wires and the one or more control commands.

In some aspects, the amount of power available over the single pair of wires may include an amount of alternating current (AC) available over the single pair of wires. In some aspects, the single pair of wires may include a single-pair ethernet (SPE) and power over data line (PoDL). In some aspects, the smart glass unit may be one of a plurality of smart glass units controlled by the controller. Receiving, by the controller over the single pair of wires, the one or more control commands indicating that the smart glass unit controlled by the controller is to change or maintain a tinting state may include receiving, by the controller over the single pair of wires, the one or more control commands indicating that the smart glass unit of the plurality of smart glass units controlled by the controller is to change or maintain a tinting state. In some aspects, the other controller may be one of a plurality of other controllers. The other smart glass unit may be one of a plurality of other smart glass units. Respective other controllers of the plurality of other controllers may control respective other smart glass units of the plurality of other smart glass units. Receiving, by the controller over the single pair of wires and from the other controller, the data concerning the tinting state of the other smart glass unit controlled by the other controller may include receiving, by the controller over the single pair of wires and from the other controller, the data concerning respective tinting states of the plurality of smart glass units controlled by the respective other controllers. In some aspects, the controller and the respective other controllers may be electrically coupled together via respective signal pairs of wires in a daisy-chain configuration. In some aspects, the controller and the respective other controllers may be electrically coupled together via respective signal pairs of wires and a bus in a dropline configuration. In some aspects, the bus may include a single pair of wires. In some aspects, the smart glass unit may include an electrochromic (EC) device.

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system comprising:
one or more smart glass units; and
one or more controllers, wherein a respective controller of the one or more controllers comprises:
a connector configured to receive a single pair of wires;
an interface to electrically connect to at least one smart glass unit of the one or more smart glass units; and
control circuitry configured to electrically control the at least one smart glass unit, via the interface, to change or maintain a tint of the at least one smart glass unit based on data received, via the connector, on the single pair of wires,
wherein the respective controller is configured to receive power, via the connector, for powering the control circuitry and for powering the interface to the at least one smart glass unit on the same single pair of wires on which the data is received.

2. The system of claim 1, wherein at least the respective controller of the one or more controllers is configured to utilize a single-pair ethernet (SPE) and power over data line (PoDL) for receiving the data and the power over the single pair of wires.

3. The system of claim 1, wherein:
the respective controller is a first controller;
the connector is a first connector;
the single pair of wires is a first single pair of wires;
the interface is a first interface;
the control circuitry is a first control circuitry;
the system further comprises:
a second controller of the one or more controllers, wherein the second controller comprises:
a second connector configured to receive a second single pair of wires;
a second interface to electrically connect to at least one other smart glass unit of the one or more smart glass units; and
a second control circuitry configured to electrically control the at least one other smart glass unit based on the data received, via the second connector, on the second single pair of wires,
wherein the second controller is configured to receive power, via the second connector, for powering the second control circuitry and for powering the second interface to the at least one other smart glass unit on the same second single pair of wires on which the data is received.

4. The system of claim 3, wherein the second single pair of wires is electrically connected to the first single pair of wires via the first connector.

5. The system of claim 4, wherein the first control circuitry is configured to determine whether to allocate, based on one or more control signals from the data received via the first single pair of wires, the power from the first single pair of wires to:
the at least one smart glass unit, via the first interface, to change or maintain a tint of the at least one smart glass unit, or
the at least one other smart glass unit, via the second interface, for powering the second control circuitry and for powering the second interface to the at least one other smart glass unit on the same second single pair of wires on which the data is received.

6. The system of claim 3, wherein the system further comprises another controller that is configured to:
determine a first amount of power for the at least one smart glass unit, via the first interface, to change or maintain a tint of the at least one smart glass unit; and
determine a second amount of power for the at least one other smart glass unit, via the second connector, for powering the second control circuitry and for powering the second interface to the at least one other smart glass unit.

7. The system of claim 3, wherein the first single pair of wires extends from the first controller, via the first connector, and electrically connects the first controller to a bus, and wherein the second single pair of wires extends from the second controller, via the second connector, and electrically connects the second controller to the same bus, wherein the bus comprises another single pair of wires.

8. The system of claim 1, wherein the one or more controllers further comprise a central controller in electrical communication, via a switch, with at least the respective controller via the single pair of wires, wherein the central controller is configured to:
transmit, via the single pair of wires and the switch, data to at least the respective controller to direct the respective controller to maintain or change tint of the at least one smart glass unit; and
provide, via the single pair of wires and the switch, power to at least the respective controller to maintain or change the tint of the at least one smart glass unit.

9. A smart glass unit system comprising:
a smart glass unit;
a controller; and
a single pair of wires extending from the controller, wherein the single pair of wires is configured to communicate power and data between the controller and at least one other controller of at least one other smart glass unit system;
the controller comprising:
a connector configured to receive the single pair of wires;
an interface to electrically connect to the smart glass unit; and
control circuitry configured to electrically control the smart glass unit via the interface to change or maintain a tint of the smart glass unit based on the data received, via the connector, on the single pair of wires,
wherein the controller is configured to receive power on the same single pair of wires on which the data is received, via the connector, for powering the control circuitry, for powering the interface to the smart glass unit, and for providing power to the smart glass unit.

10. The smart glass unit system of claim 9, wherein the controller is configured to utilize a single-pair ethernet (SPE) and power over data line (PoDL) for receiving the data and the power over the single pair of wires.

11. The smart glass unit system of claim 9, wherein the controller is further configured to receive power on the same single pair of wires on which the data is received, via the connector for providing power to the at least one other smart glass unit system.

12. The smart glass unit system of claim 9, wherein the smart glass unit comprises an electrochromic (EC) device.

13. A method implemented by a controller for controlling at least one smart glass unit in a system, the method comprising:
receiving, by the controller over a single pair of wires and from another controller, data concerning a tinting state of another smart glass unit controlled by the other controller;
receiving, by the controller over the single pair of wires, one or more control commands indicating that the smart glass unit controlled by the controller is to change or maintain a tinting state;
determining, by the controller, an amount of power available over the single pair of wires for changing or maintaining the tinting state of the smart glass unit based on the data; and
updating, by the controller, the tint state of the smart glass unit based on the amount of available power over the single pair of wires and the one or more control commands.

14. The method of claim 13, wherein the amount of power available over the single pair of wires comprises an amount of alternating current (AC) available over the single pair of wires.

15. The method of claim 13, wherein the single pair of wires comprises a single-pair ethernet (SPE) and power over data line (PoDL).

16. The method of claim 13, wherein the smart glass unit is one of a plurality of smart glass units controlled by the controller, and wherein receiving, by the controller over the single pair of wires, the one or more control commands indicating that the smart glass unit controlled by the controller is to change or maintain a tinting state comprises:
receiving, by the controller over the single pair of wires, the one or more control commands indicating that the smart glass unit of the plurality of smart glass units controlled by the controller is to change or maintain a tinting state.

17. The method of claim 13, wherein the other controller is one of a plurality of other controllers, wherein the other smart glass unit is one of a plurality of other smart glass units, wherein respective other controllers of the plurality of other controllers control respective other smart glass units of the plurality of other smart glass units, and wherein receiving, by the controller over the single pair of wires and from the other controller, the data concerning the tinting state of the other smart glass unit controlled by the other controller comprises:
receiving, by the controller over the single pair of wires and from the other controller, the data concerning respective tinting states of the plurality of smart glass units controlled by the respective other controllers.

18. The method of claim 17, wherein the controller and the respective other controllers are electrically coupled together via respective signal pairs of wires in a daisy-chain configuration.

19. The method of claim 17, wherein the controller and the respective other controllers are electrically coupled together via respective signal pairs of wires and a bus in a dropline configuration.

20. The method of claim 19, wherein the bus comprises a single pair of wires.
